(19) United States
(12) Patent Application Publication
(10) Pub. No.: US 2008/0068646 A1
(43) Pub. Date: Mar. 20, 2008

(54) PRINTING SYSTEM, INFORMATION PROCESSING APPARATUS, MAIL PROCESSING METHOD, AND STORAGE MEDIUM

(75) Inventor: Noriyuki Kobayashi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/855,410

(22) Filed: Sep. 14, 2007

(30) Foreign Application Priority Data
Sep. 15, 2006 (JP) 2006-251040

(51) Int. Cl. H04N 1/00

(52) U.S. Cl. 358/1.15

(57) ABSTRACT

A printing system includes an information processing apparatus to receive mail information transmittable to a mail receiving apparatus, and a printer communicating with the information processing apparatus. The information processing apparatus includes a unit to store transfer target printer information obtained from the mail receiving apparatus, a unit to determine whether the mail receiving apparatus can process the mail information, and a unit to transmit the mail information to the mail receiving apparatus if the determining unit determines that the mail receiving apparatus can process the received mail information, and to transfer the mail information to a printer corresponding to the transfer target printer information if the determining unit determines that the mail receiving apparatus cannot process the received mail information.

### BACKGROUND OF THE INVENTION

1. Field of the Invention

The present invention relates to a printing system including a server receiving mail information transmittable to a mail receiving apparatus and a printer capable of communicating with the server. The present invention also relates to mail processing executed among the server, the mail receiving apparatus, and the printer in the printing system.

2. Description of the Related Art

Hitherto, there is known a printing system for processing electronic mail. In a document output aid apparatus described in Japanese Laid-Open No. 2001-084191, for example, an attached document of a received electronic mail is extracted and converted to print data by application software corresponding to the attached document. The print data is sent out to a printer corresponding to a predetermined mail address. Thus, the attached file of the electronic mail is printed.

More specifically, in a document output aid method described in the above known related art, an electronic mail destined for a predetermined mail address is received by a mail receiving section. A document extracting section extracts an attached document from the received electronic mail, and an application selecting and starting-up section selects and starts up an application corresponding to the attached document. The application produces a PDL file, and a PDL transmitting section transmits the produced PDL file to a print server.

With the known related art, however, when resources of hardware and/or software of a terminal having received a mail are limited, for example, a recipient at the terminal cannot select a transfer destination of the received mail, whether automatic printing of the received mail is enabled or disabled, etc. Therefore, a mail message document and a mail attached file cannot be directly confirmed at the terminal for the mail recipient. Herein, “limitation in hardware” typically means a limitation in capacity of a memory incorporated within the terminal for the mail recipient. Also, “limitation in software” typically means the case where the terminal for the mail recipient does not include a viewer adapted for an identifier of the attached file. One example of such a case is that the terminal for the mail recipient can display a bitmap file, but it cannot display a JPEG file. In another example, the terminal for the mail recipient cannot normally display a view because of low resolution.

Stated another way, despite having received a mail, the recipient at the terminal for the mail recipient cannot confirm the content of the received mail in some cases due to the limitation in hardware and/or software of the terminal receiving the mail.

### SUMMARY OF THE INVENTION

The present invention provides an arrangement enabling a server to transmit mail information, which cannot be received by a mail receiving apparatus, to a printer set by a recipient, and to print the mail information by the printer.

In an aspect of the present invention, a printing system includes an information processing apparatus, a mail receiving apparatus, and a printer, where the information processing apparatus includes a storage unit configured to store transfer target printer information obtained from the mail receiving apparatus, a determining unit configured to determine whether the mail receiving apparatus can process the received mail information, and a transfer unit configured to transmit the received mail information to the mail receiving apparatus if the determining unit determines that the mail receiving apparatus can process the received mail information, and to transfer the received mail information to a printer corresponding to the transfer target printer information if the determining unit determines that the mail receiving apparatus cannot process the received mail information. The printer includes a printing unit configured to print the mail information transferred by the transfer unit, and the mail receiving apparatus includes a transmitting unit configured to transmit the transfer target printer information to the information processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 illustrates one example of a printing system according to a first exemplary embodiment of the present invention, which includes a server (mail server), a portable terminal for a mail recipient (mail receiving apparatus), and a printer.

FIG. 2 illustrates one example of a transfer-target printer setting UI screen which is displayed in a display portion of the terminal for the mail recipient in shown FIG. 1.

FIG. 3 is a block diagram illustrating the configuration of the terminal for the mail recipient shown in FIG. 1.

FIG. 4 is a block diagram illustrating an example of the configuration of a main part of the mail server shown in FIG. 1.

FIG. 5 is a flowchart illustrating one example of a first data processing procedure in the server according to the first exemplary embodiment.

FIG. 6 is a block diagram illustrating the configuration of a transfer target printer illustrated in FIG. 1.

FIG. 7 is a flowchart illustrating one example of a first data processing procedure in the printer according to the first exemplary embodiment.

FIG. 8 illustrates one example of a message displayed in the display portion of the terminal for the mail recipient illustrated in FIG. 1.

FIG. 9 illustrates one example of an operation UI screen displayed in a liquid crystal display of an operating unit illustrated in FIG. 6.

FIG. 10 illustrates another example of the operation UI screen displayed in the liquid crystal display of the operating unit illustrated in FIG. 6.

FIG. 11 illustrates still another example of the operation UI screen displayed in the liquid crystal display of the operating unit illustrated in FIG. 6.

FIG. 12 illustrates one example of an operation UI screen of a portable terminal according to a second exemplary embodiment.

FIG. 13 is a flowchart illustrating one example of a second data processing procedure in the server according to the second exemplary embodiment.

FIG. 14 is a flowchart illustrating one example of a third data processing procedure in a server according to a third exemplary embodiment.

FIG. 15 is a flowchart illustrating one example of a first data processing procedure in a mail receiving apparatus according to the third exemplary embodiment.

FIG. 16 is a flowchart illustrating one example of a second data processing procedure in the mail receiving apparatus according to the third exemplary embodiment.

FIG. 17 illustrates a memory map in a storage medium storing various data processing programs, which can be read by the server in the printing system of the present invention.

FIG. 18 illustrates a memory map in the storage medium storing various data processing programs, which can be read by the printer in the printing system of the present invention.

FIG. 19 illustrates a memory map in the storage medium storing various data processing programs, which can be read by the mail receiving apparatus in the printing system of the present invention.

### DESCRIPTION OF THE EMBODIMENTS

Exemplary embodiments of the present invention will be described below with reference to the drawings.

### <System Configuration>

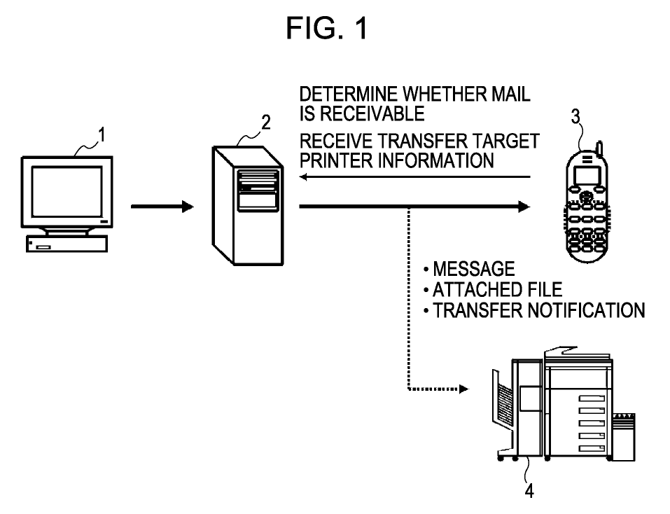

A first exemplary embodiment of the present invention will be described with reference to FIGS. 1-11.

FIG. 1 illustrates one example of a printing system according to a first exemplary embodiment of the present invention, which includes a server, a mail receiving apparatus, and a printer. In the present example, for discussion purposes, a cellular phone 3 is used as the mail receiving apparatus. However, any type of portable terminal with a data communication function, such as a PDA (Personal Digital Assistant) or a notebook personal computer that would allow practice of the present invention is applicable. Also, for discussion purposes, a mail server 2 is used as the server. However, the server can also be a data processing apparatus which implements a server function by executing an application.

Referring to FIG. 1, in ordinary sending and receiving of mail, an electronic mail transmitted from a terminal 1 for a mail sender is sent to the cellular phone 3 via the mail server 2.

The cellular phone 3 includes a function of sending an error notification to the mail server 2 when a mail message document in excess of a predetermined length and/or an attached file in excess of a predetermined capacity are sent to the cellular phone 3. Mail service is described herein, by way of example, as being executed via the mail server 2. However, the mail service can also be provided through a system executing mail processing in some other form.

In the present embodiment, receiving unit of the cellular phone 3 is includes a function such that when the cellular phone 3 cannot receive a message document and the attached file of the mail sent thereto, the content of the received file can be confirmed by using an output device. To that end, the mail server 2 registers an output device, which is located near the mail server 2, as a transfer target device to which the message document and the attached file of the mail are transferred. For example, when a mail reception error is notified from the cellular phone 3.

In the present embodiment, it is assumed that a transfer target printer 4 is registered as the output device in the mail server 2. An IP address of the transfer target printer 4 is registered in the mail server 2, and a printing instruction is issued to print the message document and/or the attached file of the mail which has been received by the mail server 2 from the mail sender terminal 1, while designating the IP address.

A method of specifying the output device is not limited to the designation of the IP address, and in other example, a port name can be designated. In the following description, the transfer target printer 4 is a nearby printer in the printing system.

With the system configuration described above, when the user operating the cellular phone 3 cannot directly confirm the content of mail sent to the cellular phone 3, the mail server 2 transfers the message document and the attached file of the received mail to the transfer target printer 4. Thus, the user can visually confirm the message document and the attached file of the mail, which are printed by the transfer target printer 4.

A print format of the attached file can be registered per user. For example, when layout printing is instructed, duplex printing can be set in order to conserve paper.

The nearby printer is not limited to a printer located near a place where the mail recipient is usually present. Any printer in any location can be used to confirm the content of the received mail.

The printing system of the present embodiment includes the mail server 2 functioning as a server receiving mail information that can be transmitted to the cellular phone 3, while the transfer target printer 4 is capable of communicating with the mail server 2.

The mail server 2 includes a data storage unit storing transfer target printer information that is obtained from the cellular phone 3. The data storage unit stores information for identifying the cellular phone 3, the name of the transfer target printer 4, limitation information, etc. in the form of a table corresponding to each terminal.

The limitation information contains the memory capacity of the cellular phone 3, the number of displayable characters, the displayable file identifier, etc. Limitation on software usable in the cellular phone 3 can also be taken into account. One example of such limitation is that a compressed file cannot be started up. Another example is that a file with specified resolution cannot be opened. Still another example is designation of an address to reject mail reception.

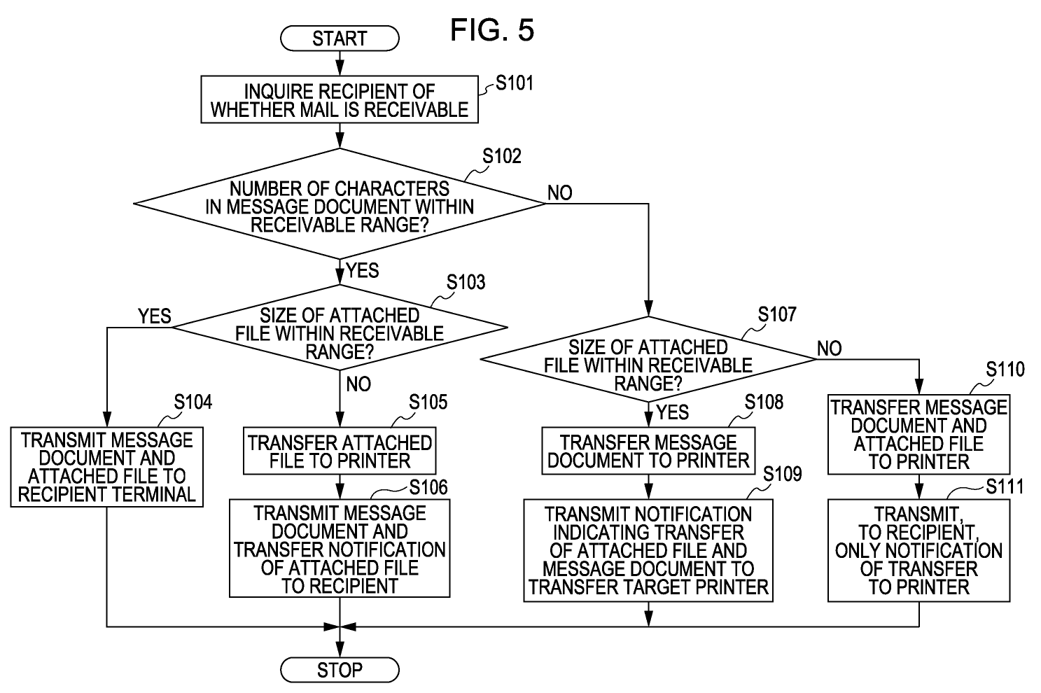

The mail server 2 also has a function of determining, based on the limitation information regarding the cellular phone 3, whether the cellular phone 3 can receive mail information received from the mail sender terminal 1. The determining function is described below with reference to FIG. 5.

In addition, the mail server 2 includes a mail processing function. If it is determined that the cellular phone 3 can receive the mail information, the mail server 2 transmits the received mail information to the cellular phone 3. On the other hand, if it is determined that the cellular phone 3 cannot receive the mail information, the mail server 2 transfers the received mail information to the transfer target printer 4 corresponding to the transfer target printer information. Further, the mail server 2 notifies the cellular phone 3 that the received mail information has been transferred to the transfer target printer 4.

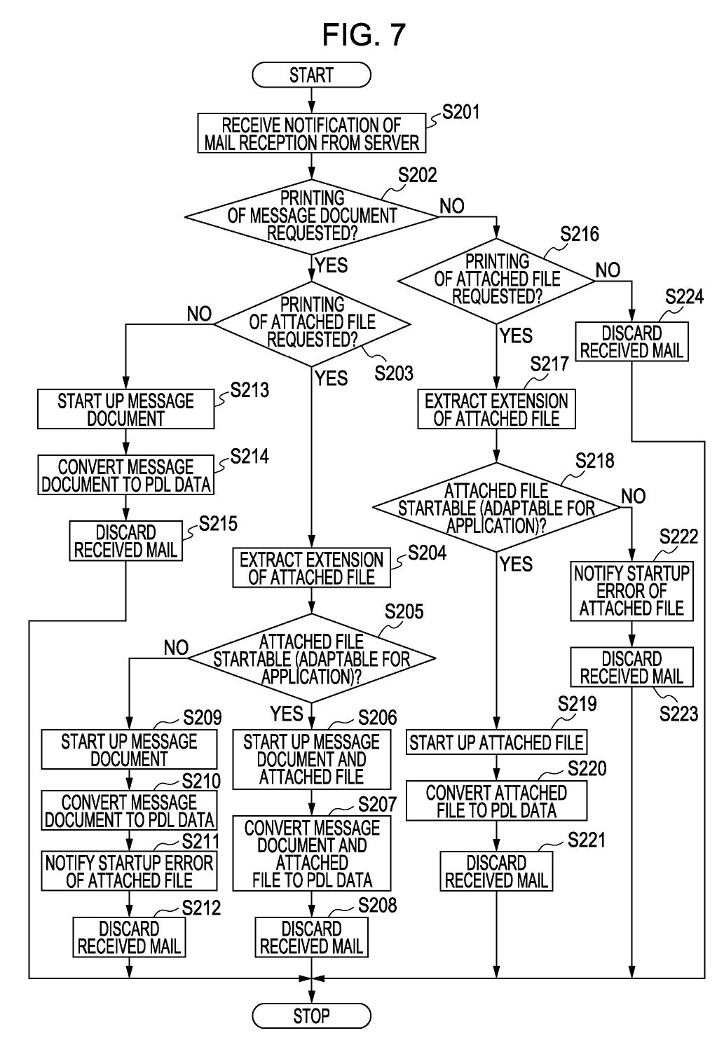

The transfer target printer 4 includes a mail determining function for determining whether it can process the mail information transferred from the mail server 2. The determination is made by checking whether the relevant mail information can be started up to be opened. Detailed processing of the mail determining function will is described below with reference to FIG. 7.

The transfer target printer 4 also includes a converting function for converting the mail information to print data capable of being processed by a printing unit when it is determined that the mail information can be processed. The data conversion is, for example, conversion of the mail information to print data based on the page description language interpretable by a printer control unit (i.e., PDL data).

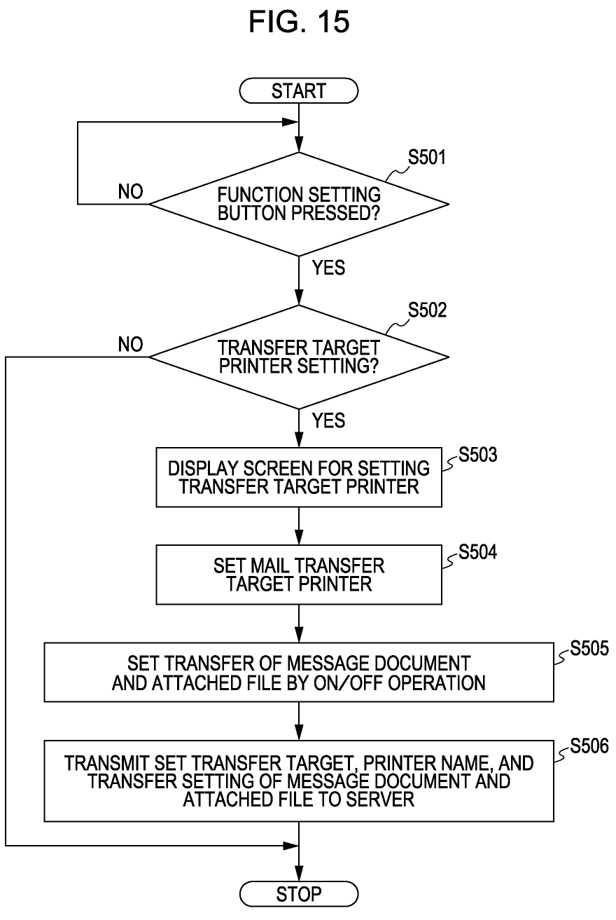

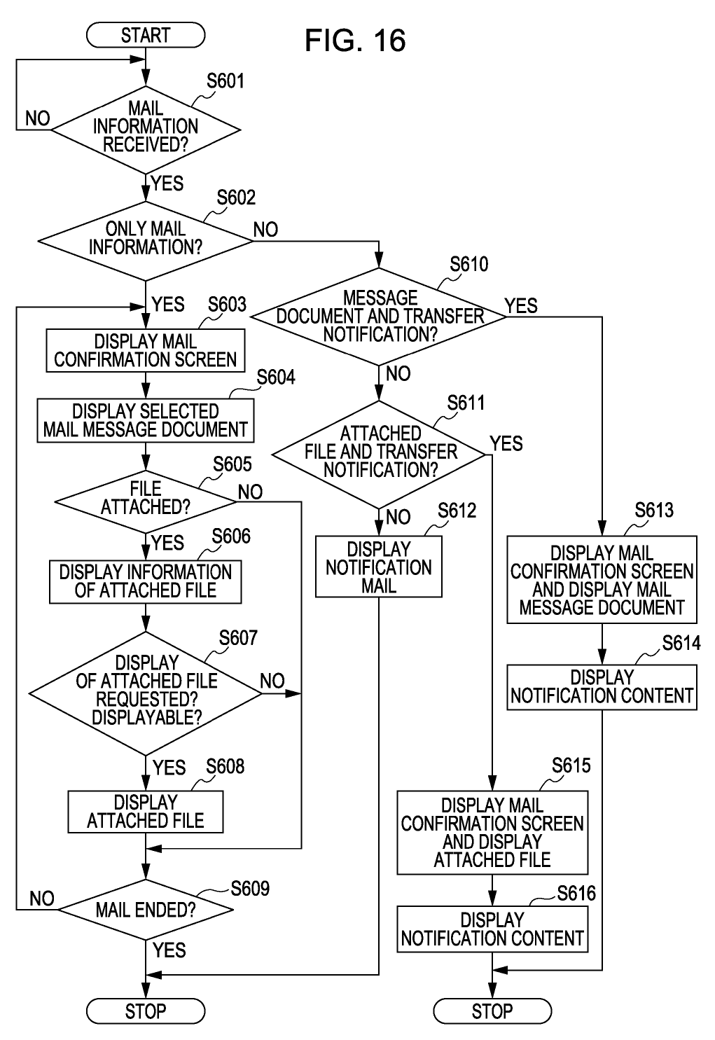

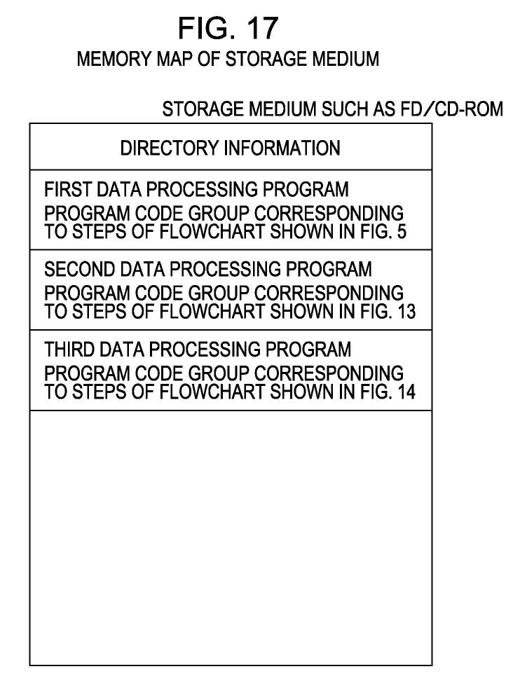

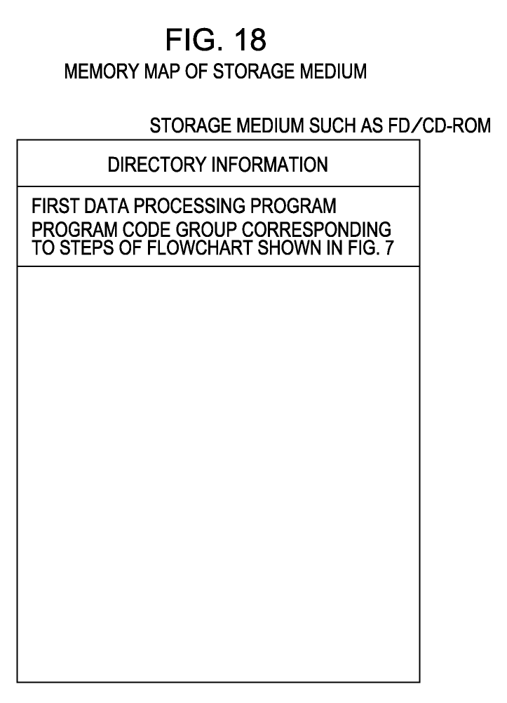

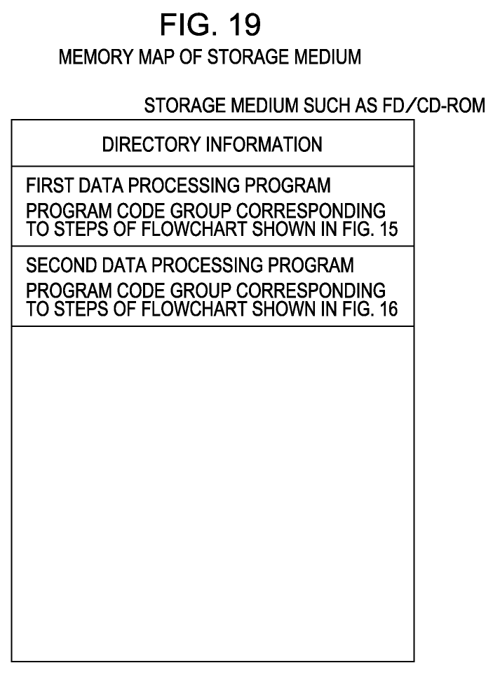

The cellular phone 3 includes a transmitting function for transmitting the information indicating the transfer target printer 4, to which the mail information is to be transferred, to the mail server 2 when the cellular phone 3 cannot receive the mail information received by the mail server 2. The transmitting function is described below with reference to FIG. 15. The cellular phone also 3 includes a first mail receiving function for receiving the receivable mail information from the mail server 2. The mail information received herein contains a mail message document and a file attached to the mail message document. Further, the cellular phone 3 includes a second mail receiving function for receiving a mail information transfer notification from the mail server 2.

The mail information transfer notification contains a message indicating that, when the mail server 2 determines based on the limitation information regarding the cellular phone 3 that the cellular phone 3 cannot receive the mail information received by the mail server 2, the relevant mail information is transferred to the transfer target printer 4. The mail information is transferred in two cases. In one case, the mail message document and the attached file which are not receivable by the cellular phone 3 are both transferred to the transfer target printer 4. In the other case, either the mail message document or the attached file is transferred to the transfer target printer 4. Therefore, the content of the mail information transfer notification also differs depending on the above two cases.

### (Configuration of Cellular Phone Terminal)

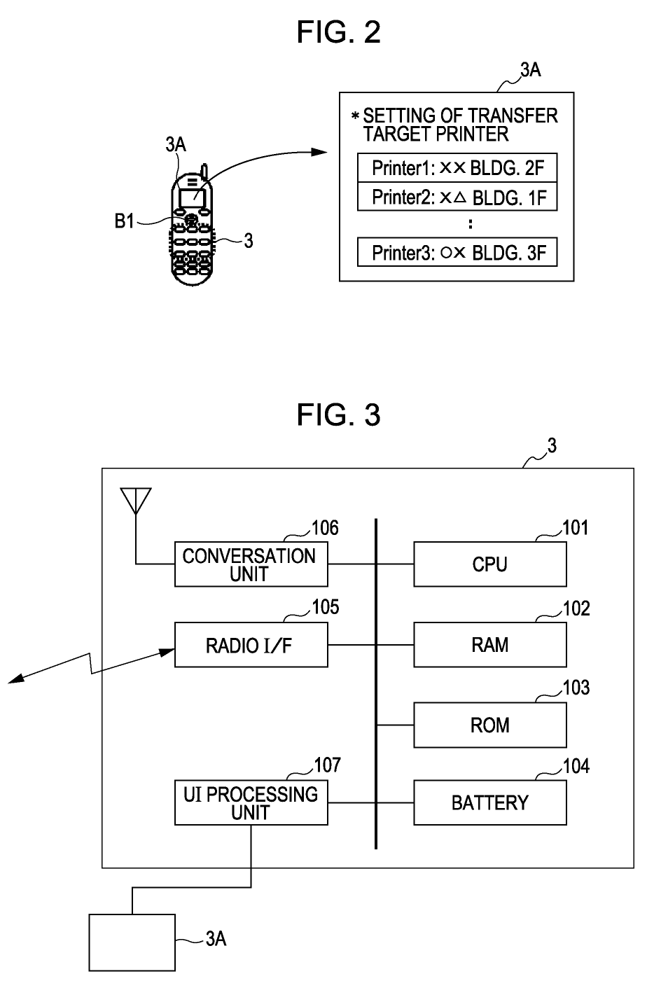

FIG. 2 illustrates one example of a transfer-target printer setting UI screen which is displayed in a display portion 3A of the cellular phone 3. The illustrated UI screen is one example of an image used for operating the cellular phone 3. A user of the cellular phone 3 inputs, on the displayed UI screen, information specifying the transfer target printer 4 by operating buttons, including a cursor button B1, arranged on the cellular phone 3.

More specifically, in FIG. 2, the user displays the transfer-target printer setting UI screen in the display portion 3A of the cellular phone 3. Further, the user registers beforehand information of printers, such as printer names and IP addresses, which are expected to be transfer targets in an internal memory of the cellular phone 3. On the UI screen, the user sets one of the registered printers to which the mail information is to be actually transferred.

FIG. 3 is a block diagram illustrating the configuration of the cellular phone 3.

In FIG. 3, a central processing unit (CPU) 101 executes data communication control of devices connected to a bus by executing a control program loaded from a ROM 103 to a RAM 102. A part of the RAM 102 functions as a nonvolatile RAM area backed up by a battery 104. A data file registered by the user is held in the nonvolatile RAM area.

A radio LAN interface 105 executes a communication process with respect to the mail server 2. A conversation unit 106 is connected to a cellular phone communication network and executes a speech data process. A UI processing unit 107 displays, in the display portion 3A, UI screens registered in the ROM 103. The UI screens displayed in the display portion 3A contain the transfer-target printer setting UI screen illustrated in FIG. 2.

The CPU 101 of the cellular phone 3 executes control for transferring data with respect to the mail server 2 via the radio LAN interface 105. Also, the CPU 101 executes control for display of the UI screen by the UI processing unit 107, conversion over a telephone, etc. Those processes are executed in accordance with programs stored in the ROM 103. In addition, upon receiving instructions from the user via the UI processing unit 107, the CPU 101 displays data stored in the ROM 103 and the nonvolatile RAM area, and executes operations corresponding to the instructions.

### (Configuration of Mail Server 2)

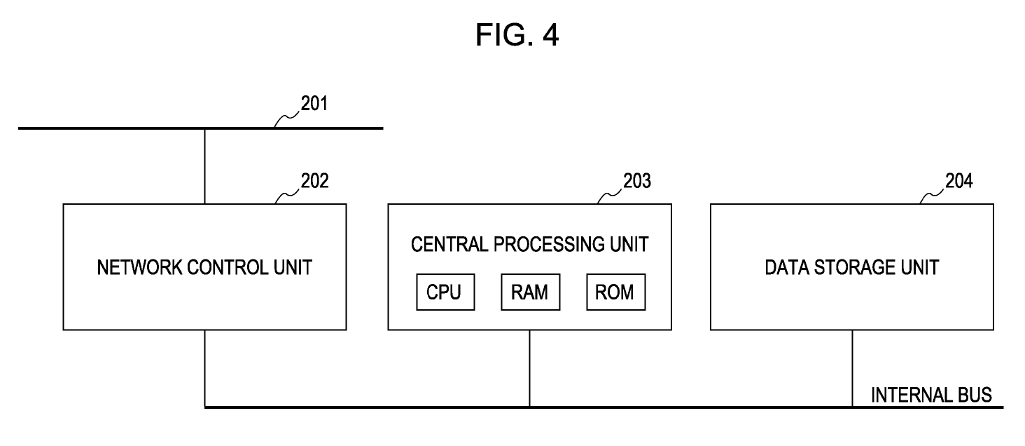

FIG. 4 is a block diagram illustrating an example of the configuration of a main part of the mail server 2 illustrated in FIG. 1. As depicted in FIG. 4, the mail server 2 of the present invention includes the same typical functions that any mail server includes.

In FIG. 4, mail data is input to a network control unit 202 via a network 201 and is converted by the network control unit 202 to a protocol and data format adapted for an internal bus of the mail server 2. The data converted to the internal bus format is processed by a central processing unit 203 including a CPU, a ROM, and a RAM. The central processing unit 203 is able to control the entire mail server 2 and to accumulate the mail message document and the attached file in a data storage unit 204. In addition to the function of sending the mail message document and the attached file to the mail recipient, the mail server 2 includes additional functions.

For example, the mail server 2 determines whether the cellular phone 3 can receive the mail message document and the attached file. Depending on the result of the determination, the mail server 2 reads out, from the cellular phone 3, the information set by the user to specify the printer to which the mail information is to be transferred. The mail server 2 then transfers the mail message document and the attached file to the set printer.

FIG. 5 is a flowchart illustrating an example of a first data processing procedure in the server according to the present embodiment. This flowchart represents the mail transfer process executed by the mail server 2. Those steps are implemented by the CPU of the mail server 2 by loading a control program from the ROM or a hard disk into the RAM and executing the control program.

First, the mail server 2 inquires whether the cellular phone 3 (recipient) is capable of receiving/accepting the mail message document and the attached file (S101). The inquiry can be performed by any method which is employed in sending and receiving mail.

Then, it is determined whether the cellular phone 3 can receive a message document containing the number of characters included in the present message document (S102).

If the CPU determines that the cellular phone 3 can receive a mail message document containing the number of characters included in the present mail message document, the processing advances to step S103. For example, if the number of characters that can be received by the cellular phone 3 is set to 256, and the number of characters used in the mail message document is determined to be less than 256, flow proceeds to step S103.

In step S103, it is determined whether the attached file is within a receivable size. If the attached file is determined to be receivable, the processing advances to step S104. For example, if the cellular phone 3 can receive files up to 500 KB, and the attached file is determined to be less than 500 KB, flow proceeds to step S104.

In step S104, the mail server 2 transmits the received mail message document and attached file to the cellular phone 3. The processing then ends. As a result, the user can confirm the received mail message document and attached file by looking at the display portion 3A of the cellular phone 3.

On the other hand, if it is determined in step S103 that the size of the attached file exceeds the set limit, the processing advances to step S105. In step S105, the mail server 2 transfers the attached file, which cannot be received by the cellular phone 3, to the transfer target printer 4 registered in the mail server 2. Then, in step S106, the mail server 2 transmits, to the cellular phone 3, the mail message document receivable by the cellular phone 3 and a notification indicating that the attached file not receivable by the cellular phone 3 has been transferred to the registered transfer target printer 4. The processing then ends.

The notification indicating that the attached file not receivable by the cellular phone 3 has been transferred to the transfer target printer 4 can be given as a message informing the transfer of the attached file to the transfer target printer 4.

If it is determined in step S102 that the number of characters in the present mail message document exceeds the limit, the processing advances to step S107. In step S107, it is determined whether the size of the attached file is within the limit. If the size of the attached file is determined to be within the limit, flow proceeds to step S108, where the mail server 2 transfers only the received mail message document the transfer target printer 4 which is registered in the mail server 2 by the user of the cellular phone 3.

Next, in step S109, the mail server 2 transmits, to the cellular phone 3, the attached file receivable by the cellular phone 3 and a notification indicating that the mail message document not receivable by the cellular phone 3 has been transferred to the registered transfer target printer 4. The processing then ends.

If it is determined in step S107 that the size of the attached file is not within the limit, the processing advances to step S110. In step S110, the mail server 2 transfers the mail message document and the attached file to the transfer target printer 4 which is registered in the mail server 2 by the user of the cellular phone 3. Then, in step Sill, the mail server 2 transmits, to the cellular phone 3, a notification indicating that the received mail message document and attached file have been transferred to the registered transfer target printer 4. The processing then ends.

Thus, only when the cellular phone 3 can receive both the mail message document and the attached file received by the mail server 2, is the user of the cellular phone 3 able to confirm their contents by looking at the display portion 3A of the cellular phone 3.

When the cellular phone 3 can receive only the mail message document received by the mail server 2 and cannot receive the attached file, the user of the cellular phone 3 receives the mail message document and the notification indicating that the mail attached file has been transferred to the transfer target printer 4. Accordingly, the user of the cellular phone 3 can confirm the content of the mail message document by looking at the display portion 3A and can receive a printed-out result at the transfer target printer 4.

When the cellular phone 3 cannot receive the mail message document received by the mail server 2 but can receive the attached file, the user of the cellular phone 3 receives the mail attached file and the notification indicating that the mail message document has been transferred to the transfer target printer 4. Accordingly, the user of the cellular phone 3 can confirm the content of the attached file by looking at the display portion 3A and can receive a printed-out result of the mail message document at the transfer target printer 4.

Further, when the cellular phone 3 cannot receive either the mail message document or the attached file received by the mail server 2, the user of the cellular phone 3 receives the notification indicating that the mail message document and the attached file have been transferred to the transfer target printer 4. Accordingly, the user of the cellular phone 3 can confirm, by looking at the display portion 3A, the notification indicating that the mail message document and the attached file have been transferred to the transfer target printer 4. Hence the user can receive printed-out results of both the mail message document and the attached file at the transfer target printer 4.

The present embodiment has been described in connection with the case of determining, based on the limitation in hardware, whether the cellular phone 3 can receive the mail message document and the attached file. However, the attached file, etc. cannot be displayed in some cases due to software resources limitations as well as or instead of hardware resources limitations.

In the case of a software resource limitation, in addition to the determination as to the reception capability illustrated in FIG. 5, the mail server 2 can also execute control to determine whether the attached file can be displayed by the software resources. Based on this determination, the attached file may be transferred to the registered transfer target printer 4 for printing it when the attached file cannot be displayed.

Consequently, even when the cellular phone 3 cannot display the mail message document and/or the attached file, which are received by the mail server 2, due to a limitation in hardware and/or software of the cellular phone 3, the user can receive their contents as the printed-out results. Further, since the place where the user receives the printed-put results can be designated as the transfer target printer registered by the user in advance, the user can obtain the printed-out results with improved convenience.

### (Configuration of Printer)

The configuration of the transfer target printer 4 is described below.

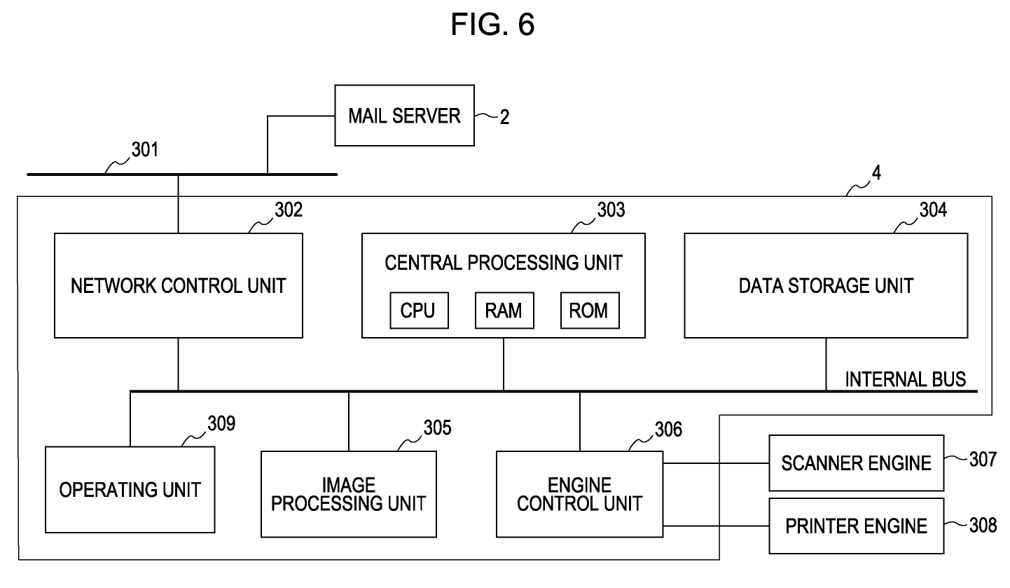

FIG. 6 is a block diagram illustrating the configuration of the transfer target printer 4. Note that in FIG. 6, the same components as those in FIG. 1 are denoted by the same reference numerals.

In FIG. 6, the mail message document and the attached file transferred from the mail server 2 are sent to a network control unit 302 via a network 301. The network control unit 302 converts data input via the network 301 to a format adapted for an internal bus while interpreting the protocol of the input data. The network control unit 302 sends the converted data to a central processing unit 303 including a CPU, a ROM, and a RAM.

The central processing unit 303 controls the entire transfer target printer 4. Further, the central processing unit 303 interprets the transferred mail input via the network 301, and upon a request for printing the mail message document and/or the attached file, it executes a process of converting the mail message document and/or the attached file to PDL data (i.e., printing command data that can be processed by the printer at a high speed), as described below.

The data converted to PDL data in the central processing unit 303 is accumulated in a data storage unit and is held therein until printing is instructed. A box area per user can be secured in the data storage unit 304. By entering user authentication information, the user can select a job held in the box area and print the selected job. The user can also delete one or more jobs selected from a job list held in the box area.

In order to avoid using up the available space in the data storage unit 304, it is best if not-yet-printed data is not held in the data storage unit 304 for a long period without entry of a printing instruction. Ensuring space availability can be met by automatically erasing data stored in the data storage unit 304 when the data is not printed by the user even after the lapse of a predetermined time preset in the printer.

When the user instructs the printing, the PDL data accumulated in the data storage unit 304 is converted by an image processing unit 305 to the bitmap format capable of being directly printed by a printer engine 308. Thereafter, the image processing unit 305 executes not only halftone correction and a filtering process of an image, but also resolution conversion as required. Bitmap data is then printed out from the printer engine 308 via an engine control unit 306.

The engine control unit 306 has a function of converting the bitmap data taken in from a scanner engine 307 to a transfer protocol adapted for the internal bus and also has a copying function of transferring the bitmap data, which has been transferred via the internal bus, to a printer engine 308 for printing the bitmap data.

Further, the transfer target printer 4 includes an operating unit 309 which displays UI screens used for performing various operations regarding the scanner function and the printer function, and UI screens used for notifying the occurrence of a failure and a recovery action from a failure. In addition, the central processing unit 303 executes a control process of determining whether the user authentication information input from the operating unit 309 is genuine or false, and deciding whether a job process request is allowed. A screen for displaying a job list, job history, and detail information, which are stored in the data storage unit 304 and managed by the central processing unit 303 of the transfer target printer 4, is described below with reference to FIG. 9.

### (Processing in Printer)

FIG. 7 is a flowchart illustrating an example of a first data processing procedure in the printer according to the present embodiment. This flowchart represents the data processing procedure for the mail message document and the attached file which are transferred from the mail server 2. The process of FIG. 7 is implemented by the CPU of the central processing unit 303 by loading a control program stored in the ROM into the RAM and executing the control program.

In some cases, as described above, the mail transferred from the mail server 2 contains the mail message document and the attached file which cannot be received by the cellular phone 3 due to the relationship between the specification, e.g., hardware limitation, of the cellular phone 3 and the data amount of the transferred mail.

The mail message document and the attached file are transferred via the mail server 2 from the cellular phone 3 to the transfer target printer 4 to be printed out. For that purpose, a control flag indicating a printing request is added to each data item. The control flag also contains print setting to decide print specifications. Examples of the print specifications include layout printing, monochrome printing of the attached file containing a color image, etc.

When the transfer target printer 4 receives the mail, it temporarily stores the mail message document and the attached file in the memory of the central processing unit 303. At that time, the transfer target printer 4 reads the control flag added to each of the mail message document and the attached file to indicate the printing instruction, thus determining whether the printing of the mail message document and/or the attached file is requested.

Turning to FIG. 7, first, the transfer target printer 4 receives a notification of mail reception from the mail server 2 (S201). Then, the central processing unit 303 determines, based on the control flag, whether the printing of the mail message document is requested (S202). If the central processing unit 303 determines that the printing of the mail message document is requested, flow proceeds to step S203, where it is determined whether the printing of the attached file is requested. If the central processing unit 303 determines that the printing of the attached file is requested, flow proceeds to step S204, where it extracts an extension of the attached file.

The central processing unit 303 determines whether there is application software installed on the data storage unit 304 to start up the attached file (S205). If the central processing unit 303 determines that the attached file can be started up, the mail message document and the attached file are started up (S206).

Then, the mail message document and the attached file are converted to PDL data, which can be analyzed by the engine control unit 306 (S207). The conversion is typically performed by a printer driver software application. In the present embodiment, the printer driver software is installed in the data storage unit 304. When a file including a printing request is received, the printer driver software is automatically started up, as with the adapted application software, thus automatically executing a series of processes required for conversion to the PDL data.

Next, the received mail held in the RAM of the central processing unit 303 is discarded (S208). The processing then ends.

On the other hand, if it is determined in step S205 that the attached file cannot be started up, only the mail message document is started up (S209). Then, the mail message document is converted to PDL using the same mechanism described above with respect to step S207 (S210).

Next, in step S211, the cellular phone 3 is notified of a startup error of the attached file via the mail server 2, thus informing the recipient of the startup error. Then, in step S212, the received mail held in the RAM of the central processing unit 303 is discarded. The processing then ends.

If it is determined in step S203 that the printing of the attached file is not requested, then in step S213, only the message document of the received mail is started up. Then, in step S214, the message document is converted to PDL data using the same mechanism described above with respect to step S207. After the series of data processing steps is completed, the received mail held in the RAM of the central processing unit 303 is discarded (S215). The processing then ends.

If it is determined in step S202 that the printing of the mail message document is not requested, the central processing unit 303 determines, based on the state of the control flag, whether the printing request for the attached file of the received mail is designated (S216). If the central processing unit 303 determines that the printing of the attached file is requested, it extracts an extension of the attached file of the received mail (S217). Then, the central processing unit 303 determines whether there is application software installed in the data storage unit 304 that can be used to start up the attached file (S218).

If the central processing unit 303 determines that the attached file of the received mail can be started up, the attached file is started up (S219). Then, the attached file is converted to PDL data using the same mechanism described above with respect to step S207. (S220). The received mail held in the RAM of the central processing unit 303 is discarded (S221), and the processing ends.

If the central processing unit 303 determines in S218 that the attached file cannot be started up, the cellular phone 3 is notified of a startup error of the attached file via the mail server 2, thus informing the recipient of the startup error (S222). Then, the received mail held in the RAM of the central processing unit 303 is discarded (S223), and the processing ends.

If it is determined in step S216 that the printing of the attached file of the received mail is not requested, this means that there is no data to be printed. Therefore, the received mail held in the RAM of the central processing unit 303 is discarded (S224), and the processing ends.

In the above description, the received mail is discarded in steps S208, S212, S215, S221, S223 and S224. However, the received mail can be stored in the data storage unit 304 so that the user can retrieve the stored data from a PC, etc.

### (Printing Operation Procedures Made by Recipient)

The printing operation procedures made by the recipient will now be described.

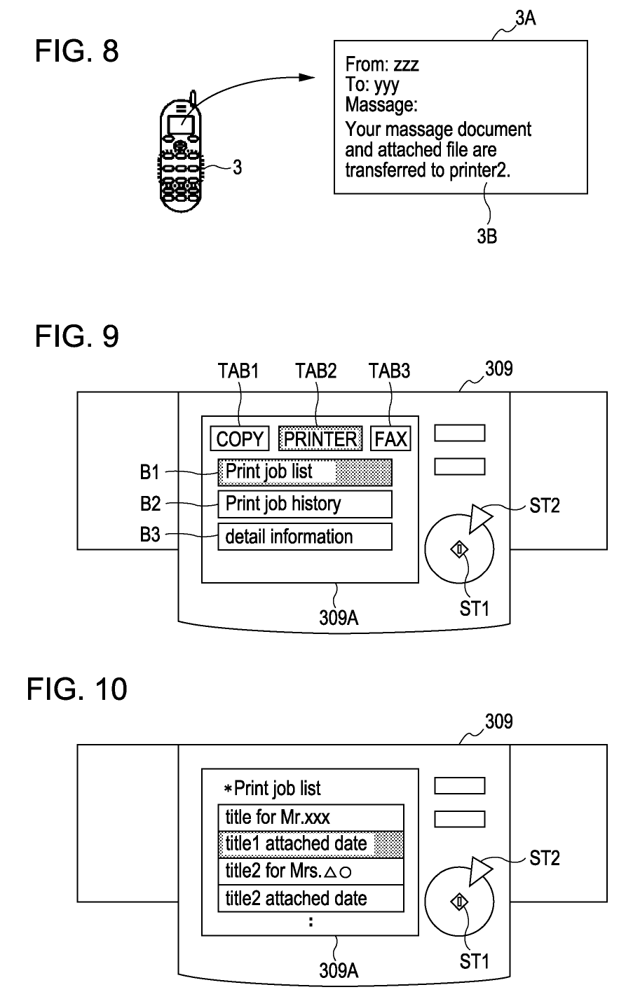

As described above, when the cellular phone 3 cannot receive the mail message document and the attached file received by the mail server 2, the mail message document and the attached file are transferred to the transfer target printer 4 as illustrated in FIG. 7. An example of a message displayed in the display portion 3A of the cellular phone 3 as described with reference to FIG. 5 is illustrated in FIG. 8.

As illustrated in FIG. 8, the message notified from the mail server 2 is displayed in a text form, including the sender, the destination, and a message body 3B. In particular, the message body 3B displayed in the display portion 3A indicates that the mail message document and the attached file are both transferred to the transfer target printer (“printer2”) registered in advance. Therefore, the message recipient who is an owner of the cellular phone 3 can confirm the contents of the mail message document and the attached file, which cannot be viewed in the display portion 3A of the cellular phone 3, by printing them by via “printer2”.

FIGS. 9-11 each illustrate an example of an operation UI screen displayed in a liquid crystal display of the operating unit 309 illustrated in FIG. 6. In FIGS. 9-11, a liquid crystal display 309A of a touch panel type includes tabs TAB1-TAB3 arranged therein for selecting the desired function. The tab TAB1 is pressed when the copying function is selected. The tab TAB2 is pressed when the printer function is selected. The tab TAB3 is pressed when the facsimile function is selected.

A start button ST1 is pressed to instruct execution of the selected function under set conditions. A stop button ST2 is pressed to stop the function under processing. Reference characters B1-B3 denote buttons. The button B1 is pressed to display a print job list. The button B2 is pressed to display print job history. The button B3 is pressed to display detail information. It is assumed that jobs displayed in the print job list are stored in the data storage unit 304 illustrated in FIG. 6.

On the touch panel of the operating unit 309 of the transfer target printer 4, the mail recipient presses the button B1 to select “print job list”. Upon selection of the button B1, the job list spooled in the data storage unit 304 is displayed in the job list format, as illustrated in FIG. 10, under control of the central processing unit 303.

In the example illustrated in FIG. 10, “print job list” is displayed. From among “print job list”, the recipient finds a job regarding a message sent to the recipient and selects it by an input operation on the touch panel of the operating unit 309.

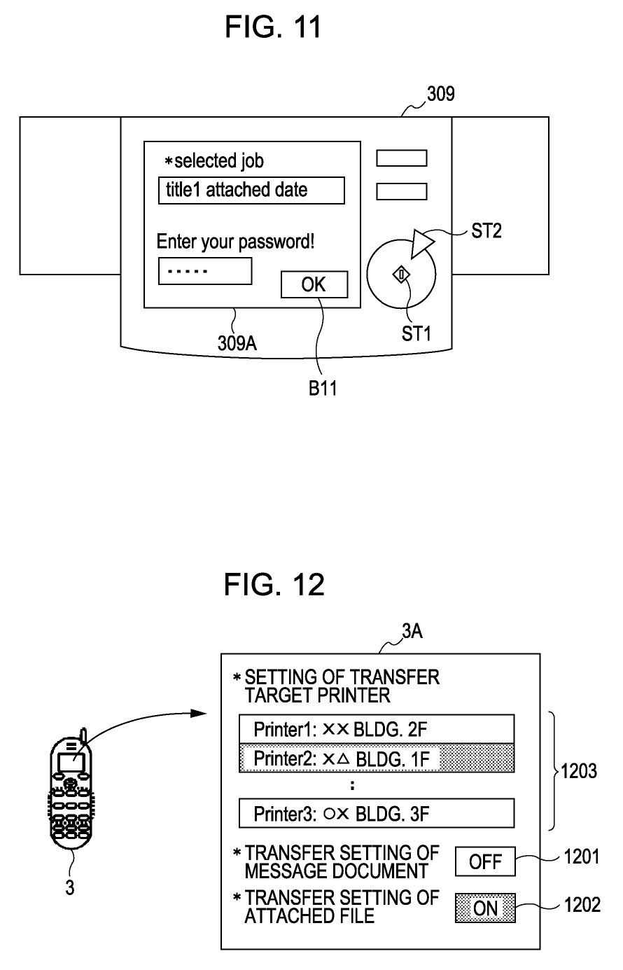

The example of FIG. 10 represents the case where a print job for the attached file corresponding to a message “title1” is selected. When the print job for the attached file corresponding to the message “title1” is selected, the selected print job and a UI box prompting the operator to input a password are displayed on the liquid crystal display 309A under control of the central processing unit 303, as illustrated in FIG. 11.

Such a prompt is displayed in order to confirm whether the operator requesting to print the mail held in the data storage unit 304 is an authenticated user. In other words, the display of such a prompting box causes the transfer target printer 4 to print out the mail after authentication of the user in consideration of security.

When the mail recipient carrying the cellular phone 3 inputs the registered password from the operating unit 309 and presses an OK button B11, printing of the print job for the attached file corresponding to the message “title1” is started.

As an alternative, when “print job list” is displayed, the transfer target printer 4 can prompt the user to input the mail address of the cellular phone 3 so that only the mail message document and the attached file, which have not been displayed at the cellular phone 3 corresponding to the input mail address, are selected and displayed. In that case, the transfer target printer 4 is required to manage the mail address of the cellular phone 3 in correspondence to the mail message document and the attached file which have not been displayed at the cellular phone 3. For example, the mail address of the cellular phone 3 can be obtained from the mail server. According to the present embodiment, as described above, when the cellular phone 3 cannot receive the mail message document and the attached file due to, e.g., the limitation in hardware and/or software, the mail recipient can view the contents of the mail message document and the attached file by printing them.

The first exemplary embodiment is described in connection with the case that, when the cellular phone 3 of the recipient cannot receive the mail message document and the attached file due to the size limitation, the mail message document and the attached file are transferred to and printed by the transfer target printer 4.

However, even when the cellular phone 3 of the recipient can receive the mail message document and the attached file because they are within the size limitation, in may instances, the user wishes to print out the contents of the mail message document and the attached file. A second exemplary embodiment of the present invention describes how to achieve this feature.

FIG. 12 illustrates an example of an operation UI screen of a portable terminal according to a second exemplary embodiment. In the present embodiment, as in the previous embodiment, the portable terminal is described, by way of example, as the cellular phone 3. However, any portable terminal, such as a PDA, that would enable practice of the present invention is applicable. Since a description of the configuration and processing of the cellular phone 3 have been provided above, only differences between the present embodiment and the previous embodiment will be described herein.

The system configuration of the present embodiment is similar to that of the previous embodiment, thus, the description of FIG. 1 above is applicable to the present embodiment and a description thereof is omitted herein.

In addition, the configuration of the transfer target printer 4 for the purposes of the description of the present embodiment is the same as in the previous embodiment. Thus, the description above with respect to the transfer target printer 4 is applicable to the present embodiment, and a description thereof is omitted herein.

The mail server of the present embodiment is the same as the mail server 2 of the previous embodiment. As such, a description thereof is omitted herein, except for any differences in the mail server 2 associated with the present embodiment.

In FIG. 12, reference numeral 1201 denotes a message-document transfer setting button which can be selectively turned ON/OFF. In the illustrated state, the button 1201 is set to OFF. Reference numeral 1202 denotes an attached-file transfer setting button which can be selectively turned ON/OFF. In the illustrated state, the button 1201 is set to ON. A job list 1203 represents the state where “printer2: xΔ bldg. 1F” is currently selected.

The illustrated state corresponds to the case that, when the cellular phone 3 receives the mail message document and the attached file from the mail server 2, only the attached file is transferred to and printed by the transfer target printer 4.

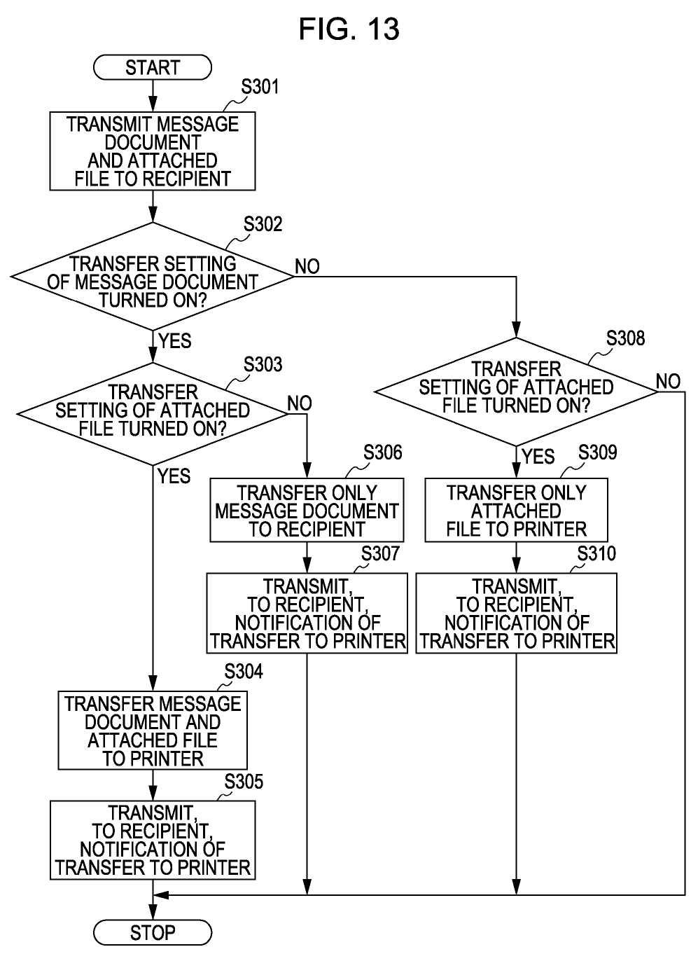

The mail recipient, i.e., the operator of the cellular phone 3, sets the transfer target printer to which the mail is to be transferred, by manipulating an operating portion of the cellular phone 3. Further, the mail recipient sets, using a button operation, whether the mail message document and the attached file are transferred to the registered transfer target printer regardless of whether the cellular phone 3 can receive the mail. The button operation is performed by turning the message-document transfer setting button 1201 and the attached-file transfer setting button 1202 ON (transfer) or OFF (not transfer) such that the setting is made for each of the mail message document and the attached file. The setting information is transferred to the mail server 2 and is registered in the data storage unit 204 per user and per the terminal for the mail recipient. The contents of the setting are referred to in below with respect to a mail transfer process illustrated in FIG. 13.

In the example illustrated in FIG. 12, the setting of transferring only the mail attached file is made effective. The mail transfer process executed by the mail server is described below with reference to FIG. 13.

FIG. 13 is a flowchart illustrating an example of a second data processing procedure in the mail server 2 according to the present embodiment. The steps illustrated in FIG. 13 are implemented by the CPU of the central processing unit 203 illustrated in FIG. 4 by loading a control program from the ROM into the RAM and executing the control program.

First, the mail server 2 transmits the mail message document and the attached file to the cellular phone 3 (S301). In the present embodiment, the mail server 2 inquires as to the transfer settings, regardless of whether the mail message document and the attached file can be received by the cellular phone 3. When the cellular phone 3 cannot receive the mail message document and the attached file, an error message is provided to the mail server 2.

First, a determination is made, based on a setting value registered in the data storage unit 204, whether the message-document transfer setting for the registered user of the cellular phone 3 is turned ON (S302). If it is determined in step S302 that the message-document transfer setting is turned ON, it is then determined whether the attached-file transfer setting is turned ON (S303). If it is determined in step S303 that the attached-file transfer setting is turned ON, the mail message document and the attached file are transferred to the transfer target printer 4 (S304).

The mail server 2 then transmits, to the cellular phone 3, a notification indicating that the mail message document and the attached filed received by the mail server 2 have been transferred to the transfer target printer 4 (S305). The processing then ends.

Following this processing, the user can then print out the mail message document and attached file at the registered transfer target printer 4. Printing is accomplished by selecting the corresponding job from a job list, as illustrated in FIG. 10, displayed on the operating unit 309.

If it is determined in step S303 that the attached-file transfer setting is turned OFF, only the mail message document is transferred to the transfer target printer 4 (S306). The mail server 2 transmits, to the cellular phone 3, a notification indicating that only the mail message document has been transferred to the registered transfer target printer 4 (S307). The processing then ends.

If it is determined in step S302 that the message-document transfer setting is turned OFF, a determination is made whether the attached-file transfer setting is turned ON (S308). If it is determined in step S308 that the attached-file transfer setting is turned ON, only the attached file is transferred to the registered transfer target printer 4 (S309). The mail server 2 transmits, to the cellular phone 3, a notification indicating that only the attached filed has been transferred to the transfer target printer 4 (S310). The processing then ends.

If it is determined in step S308 that the attached-file transfer setting is turned OFF, the processing ends and the mail is not transferred to the transfer target printer 4, and no notification is sent to the cellular phone 3.

The present embodiment differs from the previous embodiment in the following. In the previous embodiment, data not receivable by the cellular phone 3 due to a limitation in hardware and/or software is transferred from the mail server 2 to the transfer target printer 4 such that the user of the cellular phone 3 can view a printed version of the data that was automatically printed.

According to the present embodiment, even when the mail message document and the attached file can be received by the cellular phone 3, the user can instruct automatic printing of the mail message document and/or the attached file from the cellular phone 3 in which the printer driver is not installed.

Both embodiments provide the capability for a user who receives mail via a mobile terminal, e.g., cellular phone 3, to print the mail without the need for a computer.

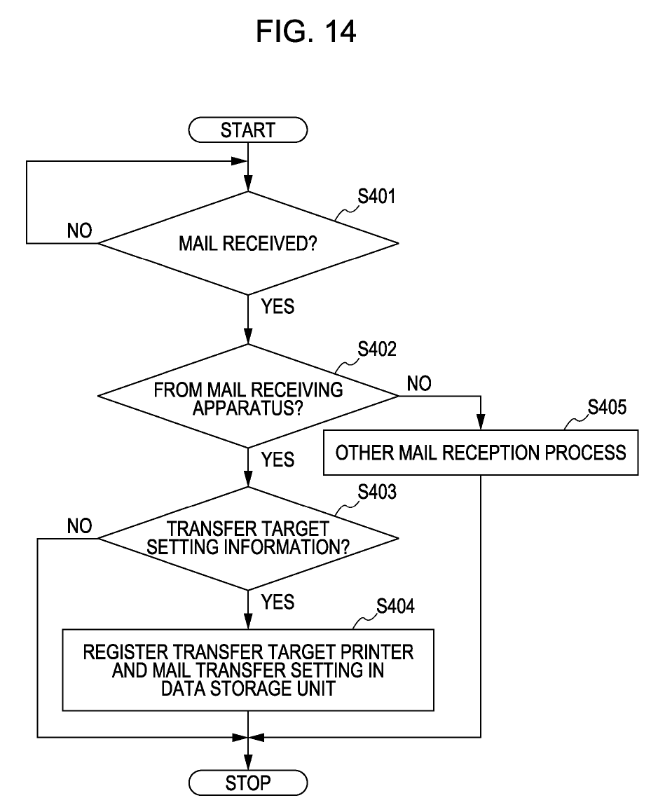

A process of registering the transfer target printer 4, which is executed between a mail receiving apparatus, e.g., cellular phone 3, and a server, e.g., mail server 2, is described below with reference to FIGS. 14 and 15.

FIG. 14 is a flowchart illustrating an example of a third data processing procedure in the mail server 2 according to a third exemplary embodiment. This flowchart represents the process of registering the transfer target printer 4, which is executed between the cellular phone terminal 3 and the mail server 2. The steps depicted in FIG. 14 are implemented by the CPU of the mail server 2 by loading a control program from the ROM or a hard disk (HD) into the RAM and executing the control program.

First, in step S401, the mail server 2 monitors the state of mail reception in a radio communication session. If it is determined that a mail is received, then in step S402, it is determined whether the mail is received from the cellular phone 3. If it is determined that the mail is received from something other than the cellular phone 3, flow proceeds to step S405, where other mail reception processing is performed. This processing includes reception of electronic mail from the mail sender 1, etc., and storing of the received mail in a designated storage location. Following step S405, the process then ends.

If it is determined in step S402 that the mail is received from the cellular phone 3, flow proceeds to step S403, where a determination is made whether the content of the received mail is transfer target setting information for setting the transfer target printer 4. If the content is not transfer target setting information, the processing ends. The determination of whether the content of the received mail is transfer setting information can be accomplished by analyzing the header of the received information. The determination process is not limited to this method, and any method that would allow practice of the present invention is applicable.

If the content is target setting information, flow proceeds to step S404. In step S404, the name of the transfer target printer and control information deciding whether the mail message document and the attached file in the mail information are to be transferred to the transfer target printer 4 is extracted from the received target setting information. The extracted mail message document and attached file in the mail information are then registered into the data storage unit 304. Then the processing ends.

FIG. 15 is a flowchart illustrating an example of a first data processing procedure in the mail receiving apparatus according to the present embodiment. This flowchart represents an example of a process of producing the control information for determining the transfer target printer to which the mail message document and the attached file in the mail information are to be transferred, and transmitting the control information to the mail server 2. The steps depicted in FIG. 15 are implemented by the CPU 101 of the cellular phone 3 by loading a control program stored in the ROM 103 into the RAM 102 and executing the control program.

First, if a function setting UI screen is displayed in the display portion 3A of the cellular phone 3 and a function setting button is pressed in step S501, in step S502 it is determined whether setting of the transfer target printer 4 is selected. If it is determined that setting of the transfer target printer 4 is not selected, the processing ends.

If it is determined in step S502 that setting of the transfer target printer 4 is selected, a UI screen for selecting the transfer target printer, e.g., the UI screen illustrated in FIG. 12, is displayed in the display portion 3A in step S503. In step S504, the operator selects a transfer target printer.

In step S505, the operator performs transfer setting for each of the mail message document and the attached file in the mail information received from the mail server 2. On the UI screen illustrated in FIG. 12, for example, the transfer setting of the message document is set ON/OFF by operating the message-document transfer setting button 1201. Also, on the same UI screen, the transfer setting of the attached file is set ON/OFF by operating the attached-file transfer setting button 1202.

Next, in step S506, the CPU 101 transmits, to the mail server 2, the name of the transfer target printer and the transfer settings of the mail message document and the attached file. The processing then ends.

Through the above-described steps, a user operating the cellular phone terminal 3 can register a transfer target printer in the mail server 2 with a simple operation. The user can also set, for the mail message document and the attached file respectively, whether they are to be transferred to the transfer target printer 4. Accordingly, the user can change the setting for the mail information from the cellular phone 3 depending on the operating environment and the current situation of the user.

Even in the situation that the attached file, etc. can be received by the cellular phone 3, the user can instruct the mail server 2 to transfer the attached file to the set transfer target printer 4 and can confirm the content of the attached file as an output result printed on paper.

FIG. 16 is a flowchart illustrating an example of a second data processing procedure in the mail receiving apparatus according to the third exemplary embodiment. This flowchart represents another example of a process of producing the control information for determining the transfer target printer to which the mail message document and the attached file in the mail information are to be transferred, and transmitting the control information to the mail server 2. The steps depicted in FIG. 16 are implemented by the CPU 101 of the cellular phone 3 by loading a control program stored in the ROM 103 into the RAM 102 and executing the control program.

First, in step S601, the cellular phone 3 determines whether mail information is received via the conversation unit 106. If the mail information is received, then in step S602, it is determined whether the content of the received mail is only the mail information.

The reason why the above determination is made is as follows. The mail server 2 receives the mail message document and the attached file as the mail information. Due to possible limitations in hardware and/or software of the cellular phone 3, the mail message document and/or the attached file can be transferred to the transfer target printer 4 which is registered based on setting made from the cellular phone 3. In the case where the mail message document and/or the attached file is transferred to the transfer target printer 4, the notification indicating their transfer is sent to the cellular phone 3.

If it is determined that there is only the mail information, a mail confirmation screen is displayed in the display portion 3A in step S603. Then, in step S604, the CPU 101 displays the mail message document in the display portion 3A with a select operation of the user from among a mail list displayed on the mail confirmation screen.

In step S605, for the displayed mail message document, it is determined whether a file is attached. If it is determined that there is no attached file, the processing ends.

If it is determined that there is an attached file, then in step S606, information associated with the attached file is displayed on a mail list screen which is displayed in the display portion 3A. Then, in step S607, it is determined whether a request for displaying the attached file on the mail list screen is instructed by a user input operation and the attached file can be displayed. If it is determined that there is no request for displaying the attached file, the processing advances to step S609.

If it is determined in step S607 that the display of the attached file is requested and the attached file can be displayed, the requested attached file is displayed in the display portion 3A.

In step S609, it is determined whether the end of the mail processing is requested from the operating portion of the cellular phone 3. If there is a display request, the processing returns to step S603, and if there is no display request, the processing ends.

If it is determined in step S602 that the received mail contains something in addition to the mail information, then in step S610, it is determined whether the received mail contains the mail message document and the transfer notification. If the mail message document and the transfer notification are received, the mail confirmation screen and the received mail message document are displayed in the display portion 3A in step S613.

Then, corresponding to the mail message document displayed in step S613, the content of the transfer notification sent from the mail server 2 is displayed in the display portion 3A in step S614. The processing then ends. The content of the transfer notification indicates that the mail server 2 has transferred the attached file to the transfer target printer 4.

If it is determined in step S610 that the mail message document and the transfer notification are not the contents of the received mail, then in step S611, it is determined whether the received mail contains the attached file and the transfer notification.

If the attached file and the transfer notification are not the contents of the received mail, then a notification mail is displayed in the display portion 3A in step S612. The processing then ends. This represents the case where the cellular phone 3 cannot display both the mail message document and the attached file in the mail information received by the mail server 2. Accordingly, the content of the notification mail indicates that both the mail message document and the attached file in the mail information received by the mail server 2 have been transferred to the registered transfer target printer 4.

If it is determined in step S611 that the attached file and the transfer notification are received, then in step S615, the received attached file is displayed in the display portion 3A. Then, corresponding to the attached file displayed in step S615, the content of the transfer notification sent from the mail server 2 is displayed in the display portion 3A in step S616. The processing then ends. In this case, the content of the transfer notification indicates that the mail server 2 has transferred the mail message document to the transfer target printer 4.

With the above-described process, even when the cellular phone 3 cannot display the mail message document and the attached file in the mail information received by the mail server 2 due to a limitation in hardware and/or software of the cellular phone 3, the user can receive the mail information as a printed-out result. Thus, the user of the cellular phone 3 can receive the printed-out result from the transfer target printer 4 which is registered in the mail server 2.

Further, in the present embodiment, the user can obtain one or both of the mail message document and the attached file in the mail information, which cannot be received by the cellular phone 3, as a printed-out result from the transfer target printer 4 depending on the user setting made on the cellular phone 3. In other words, when the mail server 2 receives mail containing content that cannot be confirmed by the cellular phone 3, the user of the cellular phone 3 can confirm the content of the received mail in the form of a print out. Hence convenience for the user is improved.

The first and second exemplary embodiments have been described as printing the mail message document and the attached file in separate pages when they are printed by the transfer target printer 4. By utilizing the layout function or the image zooming function of the image processing unit 305, however, the user can also make setting to perform layout printing of the mail message document and the attached file on the same page so that they are laid out within one page.

When the printer engine 308 includes a duplex unit, the user can make setting to perform duplex printing by using the duplex unit so that the mail message document and the attached file are separately printed on both sides of a recording medium.

Further, the user can make setting to separately utilize the layout function and the image zooming function of the image processing unit 305. More specifically, when the mail message document has a size within one page and the attached file has a size over plural pages, the layout printing can be performed so that the mail message document is printed on one page and the attached file is also printed on one page.

When the attached file has a size over many pages, it can be converted to a thumbnail format and printed on one page as a confirmation sheet allowing the user to print only the required page(s) of the attached file.

The attached file can be instructed to be printed by using, as a form overlay, an image frame registered from the cellular phone 3. In such a case, the image frame is registered in the mail server 2. The printing can also be instructed such that the attached file of the received mail is combined with another attached file held in the cellular phone 3.

The above exemplary embodiments have been described in connection with the case where user authentication information is input from the operating unit 309 of the transfer target printer 4. However, when the transfer target printer 4 can utilize an infrared communication function, the infrared communication function of the transfer target printer 4 can be combined with an infrared communication function of the cellular phone 3 to perform the user authentication process in a wireless manner.

According to the third exemplary embodiment, the recipient can obtain data in the mail information, which cannot be received by a mail receiving apparatus, as an output result printed by a printer at a preset target location. Therefore, the user can readily view, as a printed-out result, the mail information that cannot be confirmed through a display portion of a mail receiving apparatus due to hardware and/or software limitations of the mail receiving apparatus.

It is not required to install, in the mail receiving apparatus, a printer driver adapted for the transfer target printer. In other words, the mail information transferred from a server can be printed in accordance with the user-designated setting by utilizing the function of the transfer target printer.

Even when the mail receiving apparatus can receive both the mail message document and the attached file from the server, the mail information received by the server can also be printed out by the preset printer in accordance with the setting made on the mail receiving apparatus. Thus, the setting of a transfer target printer can be changed at the mail recipient terminal depending on the demand of the mail recipient.

For example, even when the mail recipient is on the road, the recipient can designate a nearby registered printer with the intent to change a mail confirmation manner from confirming the mail content displayed in the display portion of the mail receiving apparatus to confirming it as an output result printed by the preset printer. By printing the mail information, which cannot be viewed on the mail receiving apparatus, with the preset printer, the recipient can confirm the mail message document and the attached file as the printed-out result. In addition, since the confirmation manner can be separately changed for each of the mail message document and the attached file in the mail information, a user's request for the mail confirmation can be flexibly adapted and convenience for the user is improved.

The configuration of data processing programs readable by a server, a mail receiving apparatus, and a printer according to the present invention will be described below with reference to memory maps illustrated in FIGS. 17-19.

FIG. 17 illustrates a memory map in a storage medium storing various data processing programs which can be read by the server in the printing system of the present invention.

FIG. 18 illustrates a memory map in the storage medium storing various data processing programs which can be read by the printer in the printing system of the present invention.

FIG. 19 illustrates a memory map in the storage medium storing various data processing programs which can be read by the mail receiving apparatus in the printing system of the present invention.

Though not specifically shown, the storage medium can further store not only information for managing a program group stored in the storage medium, e.g., version information and the name of a creator, but also information depending on OS (operating system), etc. in the program read-out side, e.g., an icon indicating each program in an identifiable manner.

Further, data belonging to the various programs is also managed in the same directory. In some cases, the storage medium can store a program for installing the various programs in a computer, and a decompression program when the installed program is compressed.

The functions of the exemplary embodiments, illustrated in FIGS. 5, 7 and 13, can be executed by a host computer in accordance with programs externally installed. In such a situation, the present invention is also applicable to the case where an information group including the programs is supplied to an output device from a storage medium such as a CD-ROM, a flash memory, etc., or an external storage medium via a network.

The present invention includes the following. A storage medium recording software program code for realizing the functions of the above-described exemplary embodiments is supplied to a system or an apparatus. Then, a computer (CPU or MPU) incorporated in the system or the apparatus reads and executes the program code stored in the storage medium, thereby achieving the functions of the above-described exemplary embodiments.

Therefore, the program code read out from the storage medium realizes the novel functions of the present invention, and the storage medium storing the program code constitutes the present invention.

In that case, the program can have various forms, e.g., object code, a program executed by an interpreter, and script data supplied to the OS, so long as the program has the required functions.

The storage medium for supplying the program can be, e.g., a floppy disk, a hard disk, an optical disk, a magneto-optical disk (MO), CD-ROM, CD-R, CD-RW, a magnetic tape, a nonvolatile memory card, ROM, and DVD.

Thus, the program code read out from the storage medium realizes the functions of the above-described exemplary embodiments, and the storage medium storing the program code constitutes the present invention.

Further, the program can be supplied through the steps of connecting a client computer to a homepage on the Internet by using a browser in the client computer, and downloading the computer program implementing the features of the present invention in itself or a file, which contains the computer program in compressed form and which has the automatic installing function, to a recording medium, e.g., a hard disk, from the connected homepage.

As another method, program code constituting the program implementing the features of the present invention can be divided into a plurality of files, and those files can be downloaded from different homepages. In other words, the present invention includes a WWW server and an ftp server for downloading, to a plurality of users, a program file which realizes the functions and the processing executed in the present invention with a computer.

Alternatively, the program can be supplied as follows. The program implementing the features of the present invention is encrypted and stored in a storage medium, e.g., CD-ROM, for distribution to users. The user who clears predetermined conditions is allowed to download key information necessary for decryption from a homepage. The user decrypts and executes the encrypted program by using the downloaded key information, thus installing the program in the computer.

The functions of the above-described exemplary embodiments are realized with a computer executing the read program. Also, the functions of the above-described exemplary embodiments can be realized in such a manner that, for example, an OS operating on the computer executes a part or the whole of actual processing in accordance with instructions from the read program.

In addition, the functions of the above-described exemplary embodiments can be realized as follows. The program code read out from a recording medium is written in a function expansion board inserted in a computer or a memory incorporated in a function expansion unit connected to the computer. Then, a CPU or the like incorporated in the function expansion board or the function expansion unit executes a part or the whole of actual processing in accordance with instructions from the read program.

While the present invention has been described with reference to exemplary embodiments, it is to be understood that the invention is not limited to the disclosed exemplary embodiments. The scope of the following claims is to be accorded the broadest interpretation so as to encompass all modifications (including organic combinations of the exemplary embodiments), equivalent structures and functions.

This application claims the benefit of Japanese Patent Application No. 2006-251040 filed Sep. 15, 2006, which is hereby incorporated by reference herein in its entirety.

What is claimed is:

1. A printing system, the printing system comprising:
an information processing apparatus;
a mail receiving apparatus; and
a printer, wherein
the information processing apparatus comprises:
a storage unit configured to store transfer target printer information obtained from the mail receiving apparatus;
a determining unit configured to determine whether the mail receiving apparatus can process mail information received by the information processing apparatus transmittable to the mail receiving apparatus; and
a transfer unit configured to transmit received mail information to the mail receiving apparatus when the determining unit determines that the mail receiving apparatus can process the received mail information, and to transfer the received mail information to a printer corresponding to the transfer target printer information when the determining unit determines that the mail receiving apparatus cannot process the received mail information,
wherein the printer comprises a printing unit configured to print mail information transferred by the transfer unit, and
wherein the mail receiving apparatus comprises a transmitting unit configured to transmit the transfer target printer information to the information processing apparatus.

2. The printing system according to claim 1, wherein the information processing apparatus further comprises a notifying unit configured to notify the mail receiving apparatus that mail information has been transferred to the printer.

3. The printing system according to claim 1, wherein the mail information includes at least one of a mail message document and an attached file.

4. The printing system according to claim 1, wherein when the determining unit determines that the mail receiving apparatus can process a message document in the mail information but not an attached file in the mail information, the transfer unit transmits the mail message document to the mail receiving apparatus and transfers the attached file to the printer corresponding to the transfer target printer information, and
when the determining unit determines that the mail receiving apparatus can receive the attached file and cannot receive the mail message document, the transfer unit transfers the mail message document to the printer corresponding to the transfer target printer information and transmits the attached file to the mail receiving apparatus.

5. The printing system according to claim 1, wherein the printer further comprises:
a data holding unit configured to hold print data produced based on mail information transferred by the transfer unit;
a list display unit configured to display a list of print data stored in the data holding unit; and
a printing control unit configured to perform printing of the print data selected from the list of displayed print data.

6. The printing system according to claim 5, wherein the printer further comprises an authenticating unit configured to authenticate a user requesting to print print data stored in the data holding unit, wherein when the user is authenticated, the list display unit displays the list of print data stored in the data holding unit.

7. The printing system according to claim 5, wherein the printer further comprises an erasing unit configured to, when a holding period of the print data held in the data holding unit exceeds a predetermined period, erase the print data.

8. An information processing apparatus configured to receive mail information transmittable to a mail receiving apparatus, the information processing apparatus comprising:
a storage unit configured to store transfer target printer information obtained from the mail receiving apparatus;
a determining unit configured to determine whether the mail receiving apparatus can process mail information received by the information processing apparatus transmittable to the mail receiving apparatus; and
a transfer unit configured to transmit received mail information to the mail receiving apparatus when the determining unit determines that the mail receiving apparatus can process the received mail information, and to transfer the received mail information to a printer corresponding to the transfer target printer information when the determining unit determines that the mail receiving apparatus cannot process the received mail information.

9. The information processing apparatus according to claim 8, wherein the mail information includes at least one of a mail message document and an attached file.

10. A method for processing mail used in an information processing apparatus configured to receive mail information transmittable to a mail receiving apparatus, the method comprising:
storing transfer target printer information obtained from the mail receiving apparatus in a storage unit;
determining whether the mail receiving apparatus can process mail information received by the information processing apparatus transmittable to the mail receiving apparatus; and
transmitting received mail information to the mail receiving apparatus if it is determined that the mail receiving apparatus can process the received mail information, and transferring the received mail information to a printer corresponding to the transfer target printer information if the determining unit determines that the mail receiving apparatus cannot process the received mail information.

11. A computer-readable storage medium storing computer-executable process steps, the computer-executable process steps causing a computer to execute the method of claim 10.
